(19) United States
(12) Patent Application Publication
(10) Pub. No.: US 2012/0229072 A1
(43) Pub. Date: Sep. 13, 2012

(54) Light Chargeable Notebook

(76) Inventor: Yexun Ji, Shanghai (CN)

(21) Appl. No.: 13/210,892

(22) Filed: Aug. 16, 2011

(30) Foreign Application Priority Data
Mar. 9, 2011 (CN) 201110055537.4

(51) Int. Cl. H01M 10/46

(52) U.S. Cl. 320/101

(57) ABSTRACT

The notebook includes a notebook body and a solar integrated circuit plate module located on the top lid of the notebook. The solar integrated circuit plate module mentioned above is dismountable and attached to the top lid of the notebook. The solar integrated circuit plate is set on the solar integrated circuit plate module.

The solar integrated circuit plate mentioned above is connected to the notebook batteries through the control circuit of power. The solar integrated circuit plate can be mounted on one side of the solar integrated circuit plate module. A pair of solar integrated circuit plates can be mounted on both sides of the solar integrated circuit plate module.

This application claims priority from Chinese patent application CN201110055537.4 filed Mar. 9, 2011, the disclosure of which is incorporated herein by reference.

### FIELD OF THE INVENTION

The present invention relates to a chargeable notebook by the use of light energy.

### BACKGROUND OF THE INVENTION

The power supply of a notebook is usually provided by an AC power source. A notebook consists of a chargeable battery, which can provide power to the notebook in the absence of an AC power source. However, due to its limited capacity, the chargeable battery can only provide power to the notebook in a limited period of time that cannot meet the needs of users working long hours. Nowadays, the battery life of a notebook has become more and more important when the users need to take their notebook on the go. R&D persons are constantly studying on how to enhance the capacity of a chargeable battery so as to extend the battery's working time. However, so far, the improvement of the capacity of a chargeable battery is still limited; it is still unable to meet the needs of users. Solar energy is a clean energy and can generate electricity as long as there is light. Solar energy has been used more and more widely, such as with the chargeable notebook with a solar cell in CN 99123675.0.

Chargeable notebooks with a solar cell could give users the ability to choose solar energy as a source of electrical energy. The notebook mentioned above comprises a top lid, a notebook body with a chargeable battery, a control circuit of power, and a solar integrated circuit plate. The solar integrated circuit plate is located on the top lid of the notebook where it can be exposed to sunlight. The control circuit of power, the solar integrated circuit plate and the chargeable battery are electrically connected. When the top lid of the notebook pivots into the position where the solar integrated circuit plate is exposed to sunlight, the solar integrated circuit plate will collect the incident sun's rays and convert it into electricity to charge the chargeable battery while the electrical energy is fed directly to the notebook controlled by the control circuit of power.

However, since the solar integrated circuit plate is set on the exterior surface of the top lid, the notebook must be closed so that the solar integrated circuit plate faces the light source directly. But the solar integrated circuit plate on the exterior surface of the top lid cannot face the light source directly because the notebook should be opened during use, causing the solar integrated circuit plate to go into an idle state. Furthermore, the back-light from the non-display surface of the LCD screen cannot be recycled and might also waste energy.

### SUMMARY OF THE INVENTION

This invention aims to provide a chargeable notebook by the use of light energy, avoiding the limit that a notebook can only be charged in an inoperative state, while avoiding the waste of electric power due to the back-light from the non-display surface of LCD screen.

In order to achieve the above-mentioned purpose, the present invention is to provide a chargeable notebook by the use of light energy. The notebook consists of a notebook body and a solar integrated circuit plate module located on the top lid of the notebook.

The solar integrated circuit plate module mentioned above is dismountable and attached to the top lid of notebook. The solar integrated circuit plate is set on the solar integrated circuit plate module.

The solar integrated circuit plate mentioned above is connected to the notebook batteries through the control circuit of power.

A solar integrated circuit plate can be mounted on one side of the solar integrated circuit plate module. A pair of solar integrated circuit plates can be mounted on both sides of the solar integrated circuit plate module.

The control circuit of power mentioned above comprises an DC/DC adaptor, a charging selector, a charging circuit which in turn electrically connects together. It also involves an AC-DC adaptor electrically connecting the charging selector.

The present invention uses a dismountable solar integrated circuit plate module. The side with a solar integrated circuit plate of the solar integrated circuit plate module faces the LCD screen in order to absorb the back-light from the screen to produce electrical energy, thus avoiding waste of the back-light from the LCD screen when in an idle state.

### BRIEF DESCRIPTION OF THE DRAWINGS

FIG. 1 is a schematic representation of a photo-rechargeable notebook.

FIG. 2 is a schematic representation of the joint configurations of the solar integrated circuit plate.

FIG. 3 is a schematic representation of the first embodiment.

FIG. 4 is a schematic representation of the second embodiment.

FIG. 5 is a schematic representation of the third embodiment.

### DETAILED DESCRIPTION OF THE EMBODIMENTS

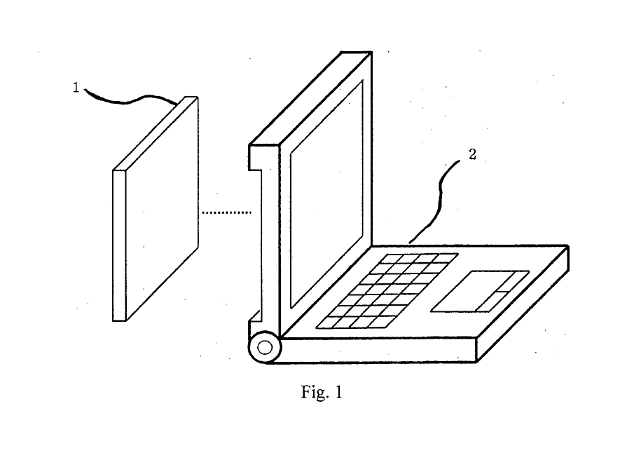

The invention will be disclosed in detail with reference to the preferred embodiments according to FIGS. 1-5.

As illustrated in FIG. 1, it is a chargeable notebook by the use of optical energy disclosed by the present invention, wherein the chargeable notebook by the use of optical energy consists of a notebook body 2 and a solar integrated circuit plate module 1 located on the top lid of the notebook.

The solar integrated circuit plate module 1 mentioned above is dismountable and attached to the top lid of the notebook. There is a solar integrated circuit plate 11 on the solar integrated circuit plate module 1.

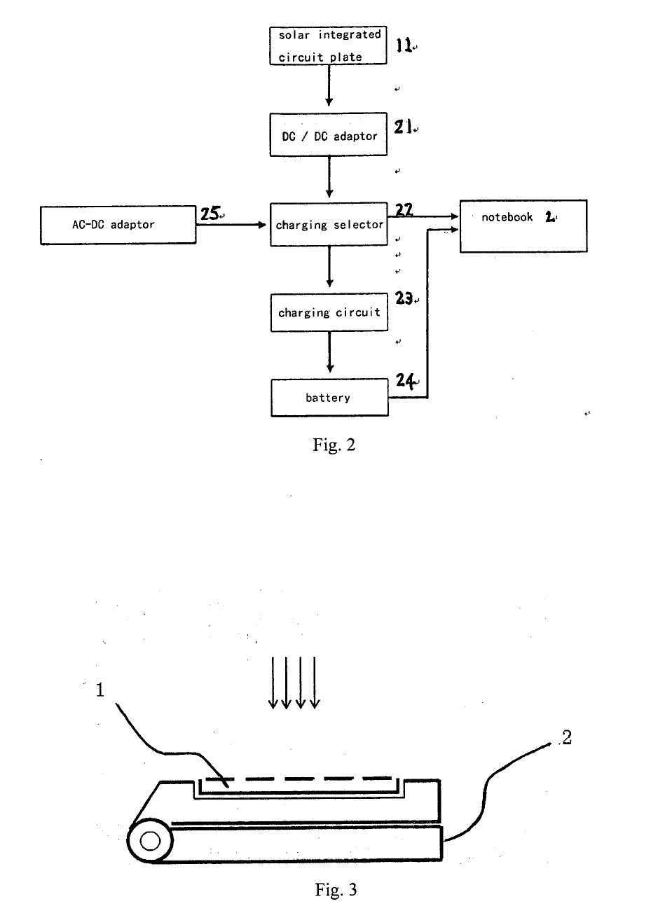

As illustrated in FIG. 2, the solar integrated circuit plate 11 mentioned above is connected to the notebook batteries 24 through the control circuit of power. The control circuit of power mentioned above comprises an DC/DC adaptor 21, a charging selector 22, a charging circuit 23 which in turn electrically connects together. It also involves an AC-DC adaptor 25 electrically connecting the charging selector 22.

During the operation from AC power supply, the AC-DC adaptor 25 mentioned above provides direct current to the charging selector 22. Then, the charging selector 22 determines whether to provide the notebook with direct current, or to supply direct current to the charging circuit 23 for charging the battery 24. When sunlight or the back-light from the LCD screen shines down on the solar integrated circuit plate 11, the solar integrated circuit plate 11 produces electricity, and provides direct current to the charging selector 22 through the DC/DC adaptor 21. Then, the charging selector 22 determines whether to provide the notebook with direct current, or to supply electricity to the charging circuit 23 for charging the battery 24.

FIG. 3 is a schematic representation of the first embodiment. There is a solar integrated circuit plate 11 on one side of the solar integrated circuit plate module 1. When the notebook 2 is in an unused condition, the top lid of the notebook should be closed, and the solar integrated circuit plate 11 of the solar integrated circuit plate module 1 should face the exterior environment that is installed on the top lid of the LCD screen of the notebook 2. This allows sunlight to shine on the solar integrated circuit plate 11 to produce electricity and charge the battery of the notebook 2.

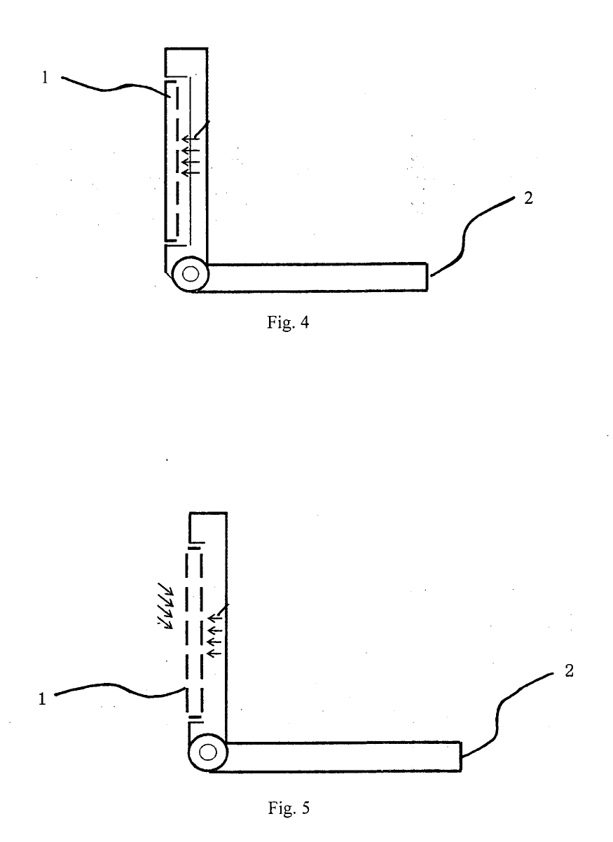

FIG. 4 is a schematic representation of the second embodiment. There is a solar integrated circuit plate 11 on one side of the solar integrated circuit plate module 1. When the notebook 2 is in use, the top lid of the notebook should be opened. The solar integrated circuit plate 11 of the solar integrated circuit plate module 1 should face the back of the LCD screen on the top lid of the notebook 2. The solar integrated circuit plate 11 can be installed on the top lid of the LCD screen of the notebook 2 to allow the back-light from the back of the LCD screen on the top lid shine down on the solar integrated circuit plate 11 to produce electricity. Then, the charging selector 22 determines whether to provide the notebook with direct current, or to supply electricity to the charging circuit 23 for charging the battery 24.

FIG. 5 is a schematic representation of the third embodiment. There is a solar integrated circuit plate 11 on both sides of the solar integrated circuit plate module 1 respectively. The solar integrated circuit plate module 1 is installed on the top lid of the LCD screen of the notebook 2. The solar integrated circuit plate 11 on one side of the solar integrated circuit plate module 1 faces the back of the LCD screen of the notebook, while the other solar integrated circuit plate 11 on the other side of the solar integrated circuit plate module 1 faces the exterior environment. Sunlight shines down on the solar integrated circuit plate 11 on one side of the solar integrated circuit plate module 1, while the back-light from the back of the LCD screen shines down on the other solar integrated circuit plate 11 on the other side of the solar integrated circuit plate module 1. Both of the solar integrated circuit plates 11 could produce electricity at the same time. Then, the charging selector 22 determines whether to provide the notebook with direct current, or to supply electricity to the charging circuit 23 for charging the battery 24. It can probably be shown as in FIG. 2, when the notebook is in an unused condition, the top lid of the notebook can be closed to allow solar energy to charge the battery of the notebook. It can also probably be shown as in FIG. 3, when the notebook is in use, electricity can be produced from the back-light from the LCD screen. Then, the charging selector 22 determines whether to provide the notebook with direct current, or to supply electricity to the charging circuit 23 for charging the battery 24.

Although the invention has been described with respect to specific embodiments for a complete and clear disclosure, the appended claims not to be thus limited, those skilled in the art will appreciate that various other embodiments can be provided without departing from the scope of the invention. Accordingly, the invention is defined only by the claims.

1. A light chargeable notebook comprising:
a) a notebook body, and
b) a solar integrated circuit plate module located on a top lid of the notebook;
wherein said solar integrated circuit plate module is dismountably attached to the top lid of notebook; and wherein the solar integrated circuit plate is set on said solar integrated circuit plate module;
wherein the solar integrated circuit plate is connected to notebook batteries through a control circuit of power.

2. The light chargeable notebook of claim 1, further comprising a solar integrated circuit plate on one side of the solar integrated circuit plate module.

3. The light chargeable notebook of claim 1, wherein a solar integrated circuit plate is mounted on both of two sides of the solar integrated circuit plate module respectively.

4. The light chargeable notebook of claim 3, wherein said control circuit of power comprises a DC/DC adaptor, a charging selector, a charging circuit which in turn electrical connected together, said control circuit of power also involves an AC-DC adaptor electrical connecting the charging selector.

5. The light chargeable notebook of claim 1, further comprising a solar integrated circuit plate on one side of the solar integrated circuit plate module, wherein said control circuit of power comprises a DC/DC adaptor, a charging selector, a charging circuit which in turn electrical connected together, said control circuit of power also involves an AC-DC adaptor electrical connecting the charging selector.
